(19) United States
(12) Patent Application Publication
(10) Pub. No.: US 2026/0100553 A1
(43) Pub. Date: Apr. 9, 2026

(54) LASER APPARATUS AND METHOD FOR MANUFACTURING ELECTRONIC DEVICE

(71) Applicant: Gigaphoton Inc., Oyama-shi (JP)

(72) Inventors: Takahito KUMAZAKI, Oyama-shi (JP); Masakazu HATTORI, Oyama-shi (JP); Kouji KAKIZAKI, Oyama-shi (JP); Takanobu ISHIHARA, Oyama-shi (JP)

(73) Assignee: Gigaphoton Inc., Oyama-shi (JP)

(21) Appl. No.: 19/404,792

(22) Filed: Dec. 1, 2025

Related U.S. Application Data
(63) Continuation of application No. PCT/JP2023/026691, filed on Jul. 20, 2023.

(51) Int. Cl. H01S 3/038; H01S 3/034; H01S 3/036; H01S 3/23

(52) U.S. Cl. CPC H01S 3/038; H01S 3/034; H01S 3/036; H01S 3/2308; H01S 3/2366

(57) ABSTRACT

A laser apparatus includes a first optical resonator including a first rear mirror and a first output coupling mirror, and a first laser chamber filled with a laser gas and including a pair of first discharge electrodes forming a discharge space where a first light beam that reciprocates in the first optical resonator passes through, a first cross-flow fan configured to circulate the laser gas in the first laser chamber, a first rectifying guide configured to direct the laser gas in the first laser chamber between the first discharge electrodes, and a pair of first windows positioned in an optical path of the first light beam. The first laser chamber is tilted in a longitudinal direction of a cross section of the first light beam relative to a first optical axis defined by the first optical resonator.

### CROSS-REFERENCE TO RELATED APPLICATIONS

The present application is a continuation application of International Application No. PCT/JP2023/026691, filed on Jul. 20, 2023, the entire contents of which are hereby incorporated by reference.

### BACKGROUND

### 1. Technical Field

The present disclosure relates to a laser apparatus and a method for manufacturing an electronic device.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

Spectral linewidths of spontaneous oscillation beams of the KrF excimer laser apparatus and the ArF excimer laser apparatus are as wide as from 350 pm to 400 pm. Therefore, when a projection lens is formed of a material that transmits ultraviolet light such as KrF and ArF laser beams, chromatic aberration may occur. As a result, the resolution may decrease. Thus, the spectral linewidth of the laser beam output from the gas laser apparatus needs to be narrowed to an extent that the chromatic aberration is ignorable. Therefore, in a laser resonator of the gas laser apparatus, a line narrowing module (LNM) including a line narrowing element (such as an etalon or a grating) may be provided in order to narrow the spectral linewidth. A gas laser apparatus with a narrowed spectral linewidth is referred to as a line narrowing gas laser apparatus.

### LIST OF DOCUMENTS

### Patent Documents

Patent Document 1: Japanese Unexamined Patent Application Publication No. 2012-094750

Patent Document 2: U.S. Patent Application Publication No. 2008/0037609

Patent Document 3: Japanese Unexamined Patent Application Publication No. 2007-221053

### SUMMARY

A laser apparatus according to one aspect of the present disclosure includes a first optical resonator and a first laser chamber. The first optical resonator includes a first rear mirror and a first output coupling mirror. The first laser chamber is filled with a laser gas and includes a pair of first discharge electrodes forming a discharge space where a first light beam that reciprocates in the first optical resonator passes through, a first cross-flow fan configured to circulate the laser gas in the first laser chamber, a first rectifying guide configured to direct the laser gas in the first laser chamber between the first discharge electrodes, and a pair of first windows positioned in an optical path of the first light beam. The first laser chamber is tilted in a longitudinal direction of a cross section of the first light beam relative to a first optical axis defined by the first optical resonator.

A method for manufacturing an electronic device according to one aspect of the present disclosure includes generating a laser beam with a laser apparatus, outputting the laser beam to an exposure apparatus, and exposing a photosensitive substrate to the laser beam in the exposure apparatus to manufacture the electronic device. The laser apparatus includes a first optical resonator including a first rear mirror and a first output coupling mirror, and a first laser chamber filled with a laser gas and including a pair of first discharge electrodes forming a discharge space where a first light beam that reciprocates in the first optical resonator passes through, a first cross-flow fan configured to circulate the laser gas in the first laser chamber, a first rectifying guide configured to direct the laser gas in the first laser chamber between the first discharge electrodes, and a pair of first windows positioned in an optical path of the first light beam, and the first laser chamber is tilted in a longitudinal direction of a cross section of the first light beam relative to a first optical axis defined by the first optical resonator.

### BRIEF DESCRIPTION OF THE DRAWINGS

Some embodiments of the present disclosure will be described below, by way of example only, with reference to the accompanying drawings.

FIG. 1 schematically illustrates a configuration of a laser apparatus according to a comparative example.

FIG. 2 illustrates a part of a power oscillator illustrated in FIG. 1 as viewed in a-Z direction.

FIG. 3 is a diagram for explaining acoustic waves generated inside a laser chamber.

FIG. 4 conceptually illustrates a refractive index distribution between discharge electrodes of the comparative example.

FIG. 5 schematically illustrates a configuration of a laser apparatus according to a first embodiment.

FIG. 6 conceptually illustrates a refractive index distribution between discharge electrodes of the first embodiment.

FIG. 7 illustrates a simulation result of a light intensity distribution in a V direction of a beam cross section of a laser beam output from a power oscillator.

FIG. 8 illustrates dimensions of parts of discharge electrodes and slits.

FIG. 9 schematically illustrates a configuration of a laser apparatus according to a first modification.

FIG. 10 schematically illustrates a configuration of a laser apparatus according to a second modification.

FIG. 11 schematically illustrates a configuration of a laser apparatus according to a third modification.

FIG. 12 schematically illustrates a configuration of a laser apparatus according to a fourth modification.

FIG. 13 schematically illustrates a configuration of a laser apparatus according to a second embodiment.

FIG. 14 schematically illustrates a configuration of a laser apparatus according to a fifth modification.

FIG. 15 schematically illustrates a configuration of an exposure apparatus connected to a laser apparatus.

### DESCRIPTION OF EMBODIMENTS

### Contents

1. Comparative Example
   1.1 Configuration of Laser Apparatus 1
      1.1.1 Master Oscillator MO
      1.1.2 Power Oscillator PO
   1.2 Operation
      1.2.1 Master Oscillator MO
      1.2.2 Beam Steering Unit 30
      1.2.3 Power Oscillator PO
      1.2.4 Laser Gas Flowing into Discharge Space DS
   1.3 Problems of Comparative Example
2. Laser Apparatus 1a with Entire Laser Chamber 10 Tilted
   2.1 Configuration
   2.2 Suppression of Deviation of Refractive Index Distribution
   2.3 Longitudinal Tilt Δθ of Discharge Electrodes 11a and 11b Relative to Optical Axis A1
   2.4 Effect
3. Wheels 18g and 18h Having Different Diameters
   3.1 Configuration
   3.2 Effect
4. Example of Tilting Laser Chamber 20 of Master Oscillator MO
   4.1 Configuration
   4.2 Effect
5. Example of Tilting both Laser Chambers 10 and 20
   5.1 Configuration
   5.2 Effect
6. Example of Not Including Power Oscillator PO
7. Laser Apparatus 1f with Tilted Optical Resonator
   7.1 Configuration
   7.2 Effect
8. Example of Tilting Cavity Plates 19e and 19f
   8.1 Configuration
   8.2 Effect
9. Others

Hereinafter, embodiments of the present disclosure will be described below in detail with reference to the drawings. The embodiments described below show some examples of the present disclosure and do not limit contents of the present disclosure. In addition, all configurations and operations described in the embodiments are not necessarily essential as configurations and operations of the present disclosure. Here, the same components are denoted by the same reference signs, and any redundant description thereof is omitted.

### 1. Comparative Example

### 1.1 Configuration of Laser Apparatus 1

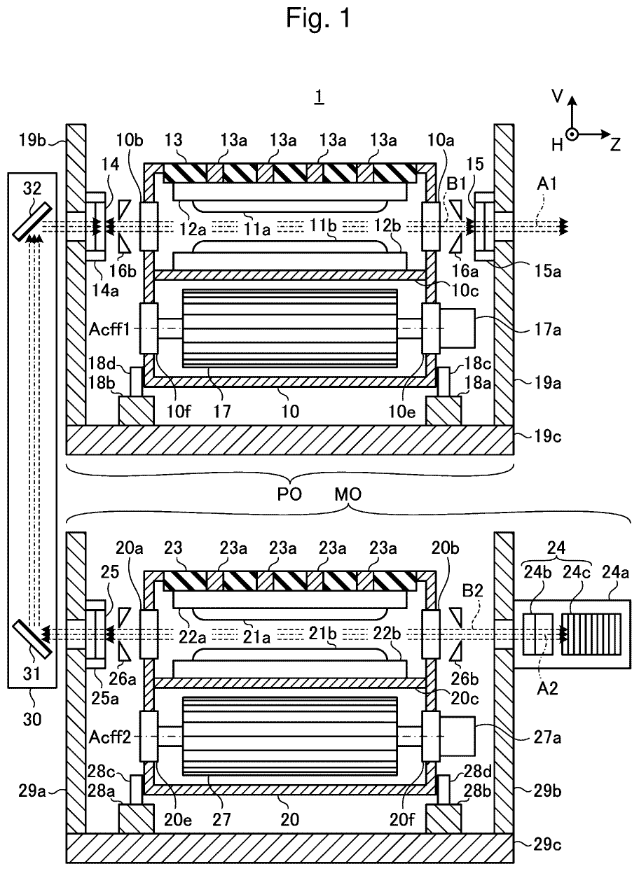

FIG. 1 schematically illustrates a configuration of the laser apparatus 1 according to the comparative example. The comparative example of the present disclosure is an example recognized by the applicant as known only by the applicant, and is not a publicly known example admitted by the applicant. The laser apparatus 1 includes a master oscillator MO, a power oscillator PO, and a beam steering unit 30. The beam steering unit 30 includes high reflective mirrors 31 and 32.

### 1.1.1 Master Oscillator MO

The master oscillator MO includes a laser chamber 20, a rear mirror 24, an output coupling mirror 25, a pair of slits 26a and 26b, a pair of rails 28a and 28b, a plurality of wheels 28c and 28d, and a pair of cavity plates 29a and 29b. The rear mirror 24 and the output coupling mirror 25 form an optical resonator. The rear mirror 24 includes a prism 24b and a grating 24c, forming a line narrowing module. Alternatively, the rear mirror 24 may be a high reflective mirror. The output coupling mirror 25 is a partial reflective mirror. The laser chamber 20 is disposed on an optical path of the optical resonator.

The laser chamber 20 includes a pair of windows 20a and 20b, a pair of discharge electrodes 21a and 21b, rectifying guides 22a and 22b, and a cross-flow fan 27. The windows 20a and 20b are positioned on an optical path of a light beam B2 that reciprocates in the optical resonator.

A traveling direction of the light beam B2 that reciprocates in the optical resonator is a Z direction or a −Z direction. A discharge direction between the discharge electrodes 21a and 21b is a V direction or a −V direction. The Z direction and the V direction are perpendicular to each other, and a direction perpendicular to both is an H direction or a −H direction.

The laser chamber 20 is filled with a laser gas containing, for example, an argon gas or a krypton gas as a rare gas, a fluorine gas as a halogen gas, and a neon gas as a buffer gas. Alternatively, a laser gas containing a fluorine gas and a buffer gas may be enclosed.

An opening is formed in a part of the laser chamber 20, and this opening is closed by an electrically insulating part 23. The electrically insulating part 23 supports the discharge electrode 21a. A plurality of conductive parts 23a are embedded in the electrically insulating part 23. Each of the conductive parts 23a is electrically connected to the discharge electrode 21a. A non-illustrated pulse power source is connected to the discharge electrode 21a via the conductive parts 23a.

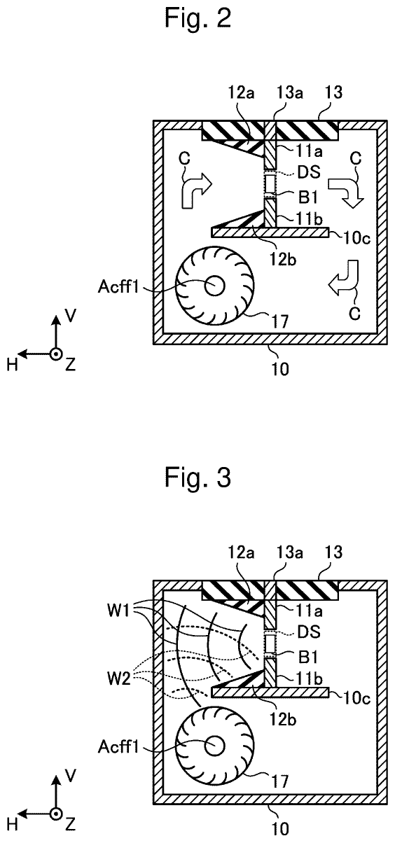

A return plate 20c is disposed inside the laser chamber 20. The discharge electrode 21b is supported by the return plate 20c. The discharge electrode 21b is electrically connected to ground potential via the return plate 20c and a conductive member of the laser chamber 20. The return plate 20c has a gap (see FIG. 2) for the laser gas to pass through on a back side and a front side of a plane of FIG. 1.

The cross-flow fan 27 is supported by bearings 20e and 20f and is connected to a motor 27a disposed outside the laser chamber 20.

The slit 26a is disposed between the output coupling mirror 25 and the laser chamber 20, and the slit 26b is disposed between the rear mirror 24 and the laser chamber 20. The slits 26a and 26b are configured to limit a V-direction beam width of the light beam B2 that reciprocates in the optical resonator.

The rails 28a and 28b are disposed near ends of the laser chamber 20 in the −Z direction and the Z direction, respectively. The H direction that is a longitudinal direction of each of the rails 28a and 28b corresponds to a chamber moving direction.

The wheels 28c and 28d are also disposed near the ends of the laser chamber 20 in the −Z direction and the Z direction, respectively. By moving the wheels 28c and 28d along the rails 28a and 28b, the laser chamber 20 is moved along the rails 28a and 28b, allowing for installation and maintenance of the laser chamber 20.

The rear mirror 24 is supported by the cavity plate 29b via a holder 24a, and the output coupling mirror 25 is supported by the cavity plate 29a via a holder 25a. The cavity plates 29a and 29b are supported by a base plate 29c.

The rails 28a and 28b and the wheels 28c and 28d are not limited to being disposed near the ends of the laser chamber 20 in the −Z direction and the Z direction, but may be disposed on either side of a plane that is parallel to a VH plane and passes through a centroid of the laser chamber 20. Further, without being limited to a case where the rails 28a and 28b are fixed to the base plate 29c and the wheels 28c and 28d are rotatably supported relative to the laser chamber 20, the rails 28a and 28b may be fixed to the laser chamber 20 and the wheels 28c and 28d may be rotatably supported relative to the base plate 29c.

### 1.1.2 Power Oscillator PO

Components of the power oscillator PO may be similar to the components of the master oscillator MO. While signs of the components of the master oscillator MO are prefixed with “2”, those of the power oscillator PO are prefixed with “1”.

However, while the rear mirror 24 included in the master oscillator MO forms the line narrowing module, a rear mirror 14 included in the power oscillator PO is formed of a partial reflective mirror. The rear mirror 14 has a higher reflectance than an output coupling mirror 15.

### 1.2 Operation

### 1.2.1 Master Oscillator MO

In the master oscillator MO, the pulse power source connected to the discharge electrode 21a generates a pulsed high voltage. When the high voltage is applied between the discharge electrodes 21a and 21b, discharge occurs in a discharge space between the discharge electrodes 21a and 21b. By energy of the discharge, a laser medium in the laser chamber 20 is excited and shifts to a high energy level. When the excited laser medium then shifts to a low energy level, light having a wavelength corresponding to the energy level difference is discharged.

The light generated in the laser chamber 20 is output to outside of the laser chamber 20 through the windows 20a and 20b. An H-direction beam width of the light output from the window 20b of the laser chamber 20 is expanded through the prism 24b and the light is incident on the grating 24c.

The light incident on the grating 24c is reflected by a plurality of grooves of the grating 24c and is diffracted in a direction corresponding to the wavelength of the light. By matching an incident angle of the light incident on the grating 24c with a diffracting angle of diffracted light having a desired wavelength, the wavelength of the diffracted light incident on the prism 24b from the grating 24c is selected. The prism 24b reduces an H-direction beam width of the diffracted light incident from the grating 24c and returns the light to the laser chamber 20 through the window 20b.

The output coupling mirror 25 transmits and outputs a portion of the light output from the window 20a of the laser chamber 20, and reflects the other portion back into the laser chamber 20.

In this way, the light output from the laser chamber 20 reciprocates along an optical axis A2 defined by the optical resonator between the rear mirror 24 and the output coupling mirror 25, and is amplified every time of passing through the discharge space between the discharge electrodes 21a and 21b. The light is subjected to line narrowing every time it is reflected back by the rear mirror 24 forming the line narrowing module. The light subjected to laser oscillation and line narrowing in this manner is output as a laser beam from the output coupling mirror 25.

### 1.2.2 Beam Steering Unit 30

The beam steering unit 30 directs the laser beam output from the master oscillator MO to the rear mirror 14 of the power oscillator PO. The beam steering unit 30 is capable of adjusting an optical axis of the laser beam so that the laser beam is incident on the rear mirror 14 of the power oscillator PO in a desired incident direction.

### 1.2.3 Power Oscillator PO

In the power oscillator PO, a pulse power source connected to a discharge electrode 11a generates a pulsed high voltage. Discharge timings of the master oscillator MO and the power oscillator PO are controlled so as to synchronize a timing at which the discharge occurs between the discharge electrodes 11a and 11b and a timing at which the laser beam output from the master oscillator MO enters the laser chamber 10 through the rear mirror 14 and a window 10b.

A light beam B1, which is the laser beam, reciprocates along an optical axis A1 defined by the optical resonator between the rear mirror 14 and the output coupling mirror 15, and is amplified every time of passing through a discharge space between the discharge electrodes 11a and 11b. The amplified laser beam is output from the output coupling mirror 15.

1.2.4 Laser Gas Flowing into Discharge Space DS

FIG. 2 illustrates a part of the power oscillator illustrated in FIG. 1 as viewed in the −Z direction. The light beam B1 passes through a discharge space DS formed between the discharge electrodes 11a and 11b. In a vicinity of the discharge electrodes 11a and 11b, a beam divergence and a spectral width may become unstable due to local concentration of the discharge. Therefore, beam quality is ensured by blocking rays passing through the vicinity of the discharge electrodes 11a and 11b with slits 16a and 16b (see FIG. 1). Thus, a V-direction beam width of the light beam B1 that reciprocates in the optical resonator becomes narrower than a V-direction width of the discharge space DS. On the other hand, an H-direction beam width of the light beam B1 is smaller than the V-direction beam width and is approximately equal to an H-direction width of the discharge electrodes 11a and 11b. A longitudinal direction of a cross section of the light beam B1 corresponds to the V direction.

When a motor 17a rotates a cross-flow fan 17 around a rotation axis Acff1, the laser gas flows and circulates inside the laser chamber 10 as indicated with arrows C in FIG. 2. Discharge products generated by the discharge between the discharge electrodes 11a and 11b are removed from the discharge space DS by a flow of the laser gas before the next discharge, resulting in a state with fewer discharge products in the discharge space DS and its vicinity, so that the discharge can be stabilized.

Rectifying guides 12a and 12b direct the laser gas between the discharge electrodes 11a and 11b. The rectifying guides 12a and 12b are formed in a tapered shape so as to allow the laser gas to flow efficiently.

While FIG. 2 illustrates the components of the power oscillator PO, the components of the master oscillator MO are similar. The cross-flow fan 27 rotates around a rotation axis Acff2 (see FIG. 1).

### 1.3 Problems of Comparative Example

FIG. 3 is a diagram for explaining acoustic waves W1 and W2 generated inside the laser chamber 10. FIG. 3 corresponds to an illustration of the acoustic waves W1 and W2 instead of the omitted arrows C indicating the gas flow in FIG. 2. In the discharge space DS between the discharge electrodes 11a and 11b, a compressional wave of the gas is generated by excitation and heating of the gas in the discharge space DS in synchronization with the discharge timing. The compressional wave generated in the discharge space DS is propagated through a space in the laser chamber 10. The compressional wave is referred to as the acoustic wave W1. The acoustic wave W1 hits components in the laser chamber 10, such as the cross-flow fan 17 and the rectifying guides 12a and 12b, and is reflected. When the reflected acoustic wave W2 reaches the discharge space DS, a refractive index distribution becomes non-uniform due to density of the laser gas in the discharge space DS. Since each ray included in the light beam B1 that reciprocates in the optical resonator is bent according to a gradient of a refractive index, a light intensity distribution on a beam cross section of the light beam B1 may become non-uniform.

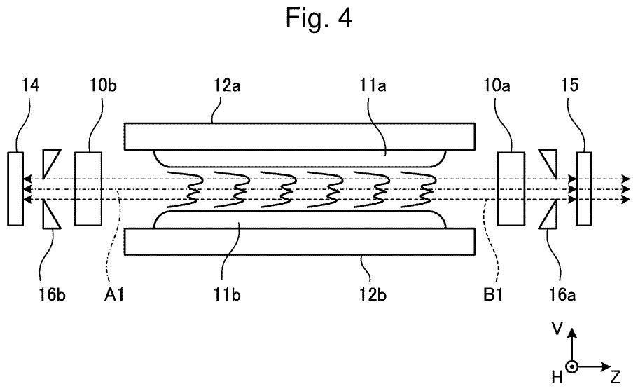

FIG. 4 conceptually illustrates the refractive index distribution between the discharge electrodes 11a and 11b of the comparative example. Each curve illustrated between the discharge electrodes 11a and 11b indicates the refractive index distribution in a discharge direction at each position along an optical path of the light beam B1. This refractive index distribution is not uniform in the discharge direction between the discharge electrodes 11a and 11b, but is nearly uniform in a longitudinal direction of the discharge electrodes 11a and 11b. In this case, since influence of the refractive index distribution on the light beam B1 accumulates along the longitudinal direction of the discharge electrodes 11a and 11b, a deviation is caused in the light intensity distribution on the beam cross section, and optical elements such as the output coupling mirror 15 may be locally damaged.

As one solution, it is conceivable to tilt the discharge electrodes 11a and 11b relative to the optical axis A1 defined by the optical resonator, so that the refractive index distribution in the longitudinal direction of the discharge electrodes 11a and 11b is not uniform. However, when the discharge electrodes 11a and 11b are tilted, a flow rate of the laser gas in the discharge space DS decreases and laser performances such as pulse energy stability of the laser beam decrease.

While issues of the acoustic waves W1 and W2 in the power oscillator PO have been described here, the same applies to the master oscillator MO.

Some embodiments described below are related to suppressing occurrence of the deviation in the light intensity distribution on the beam cross section, as well as suppressing decrease of the flow rate of the laser gas in the discharge space DS.

### 2. Laser Apparatus 1a with Entire Laser Chamber 10 Tilted

### 2.1 Configuration

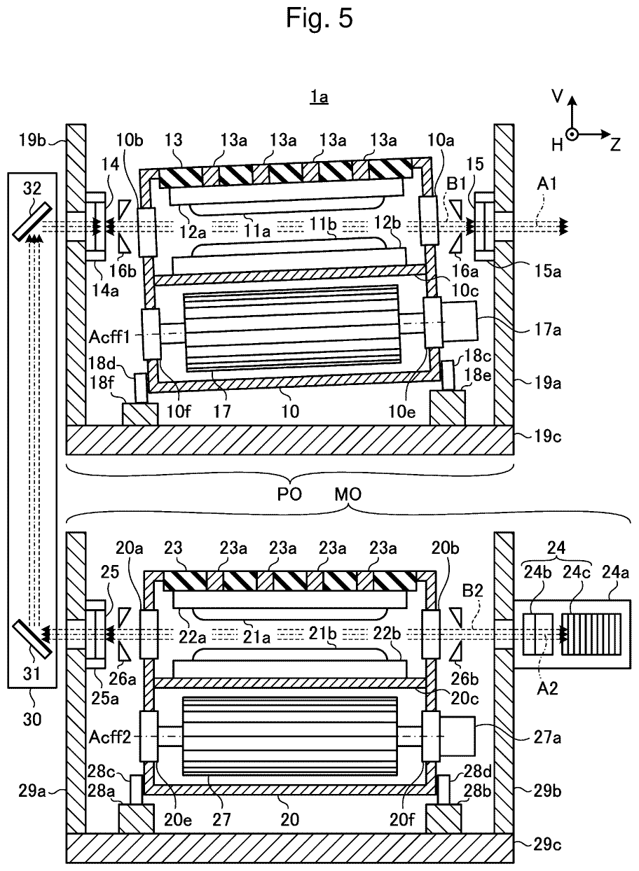

FIG. 5 schematically illustrates a configuration of a laser apparatus 1a according to a first embodiment. In the laser apparatus 1a, the laser chamber 10 of the power oscillator PO is disposed with a tilt in the V direction relative to the optical axis A1 defined by the optical resonator of the power oscillator PO, together with the discharge electrodes 11a and 11b, the cross-flow fan 17, and the rectifying guides 12a and 12b housed in the laser chamber 10. The longitudinal direction of the discharge electrodes 11a and 11b is approximately parallel to the rotation axis Acff1 of the cross-flow fan 17, and the longitudinal direction of the discharge electrodes 11a and 11b is approximately parallel to the longitudinal direction of the rectifying guides 12a and 12b.

Instead of the rails 18a and 18b in the comparative example, rails 18e and 18f are used in the first embodiment. Since the lengths of the rails 18e and 18f along the V direction are different from each other, the laser chamber 10 is disposed with a tilt.

The laser chamber 10 in the first embodiment corresponds to a first laser chamber in the present disclosure, and windows 10a and 10b in the first embodiment correspond to first windows in the present disclosure. The discharge electrodes 11a and 11b in the first embodiment correspond to first discharge electrodes in the present disclosure, and the rectifying guides 12a and 12b in the first embodiment correspond to first rectifying guides in the present disclosure. The rear mirror 14 in the first embodiment corresponds to a first rear mirror in the present disclosure, the output coupling mirror 15 in the first embodiment corresponds to a first output coupling mirror in the present disclosure, and the optical resonator formed of the rear mirror 14 and the output coupling mirror 15 in the first embodiment corresponds to a first optical resonator in the present disclosure. The cross-flow fan 17 in the first embodiment corresponds to a first cross-flow fan in the present disclosure. The optical axis A1 in the first embodiment corresponds to a first optical axis in the present disclosure, and the light beam B1 in the first embodiment corresponds to a first light beam in the present disclosure.

The laser chamber 20 of the master oscillator MO is similar to that of the comparative example.

The laser chamber 20 in the first embodiment corresponds to a second laser chamber in the present disclosure, and the windows 20a and 20b in the first embodiment correspond to second windows in the present disclosure. The discharge electrodes 21a and 21b in the first embodiment correspond to second discharge electrodes in the present disclosure, and the rectifying guides 22a and 22b in the first embodiment correspond to second rectifying guides in the present disclosure. The rear mirror 24 in the first embodiment corresponds to a second rear mirror in the present disclosure, and the output coupling mirror 25 in the first embodiment corresponds to a second output coupling mirror in the present disclosure, and the optical resonator formed of the rear mirror 24 and the output coupling mirror 25 in the first embodiment corresponds to a second optical resonator in the present disclosure. The cross-flow fan 27 in the first embodiment corresponds to a second cross-flow fan in the present disclosure. The optical axis A2 in the first embodiment corresponds to a second optical axis in the present disclosure, and the light beam B2 in the first embodiment corresponds to a second light beam in the present disclosure.

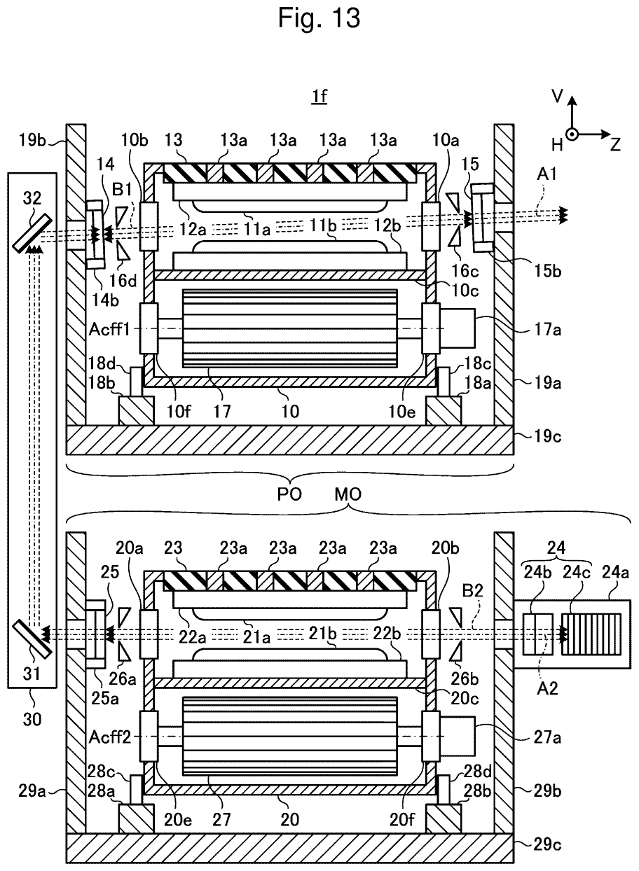

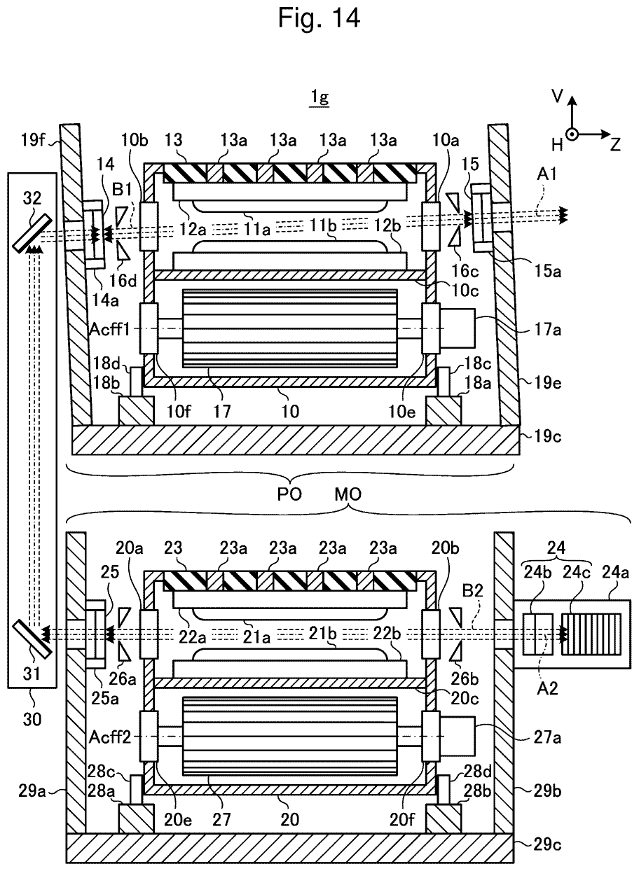

The optical axes A1 and A2 are approximately parallel. A case where the optical axes A1 and A2 are not parallel will be described later with reference to FIG. 13 and FIG. 14.

### 2.2 Suppression of Deviation of Refractive Index Distribution

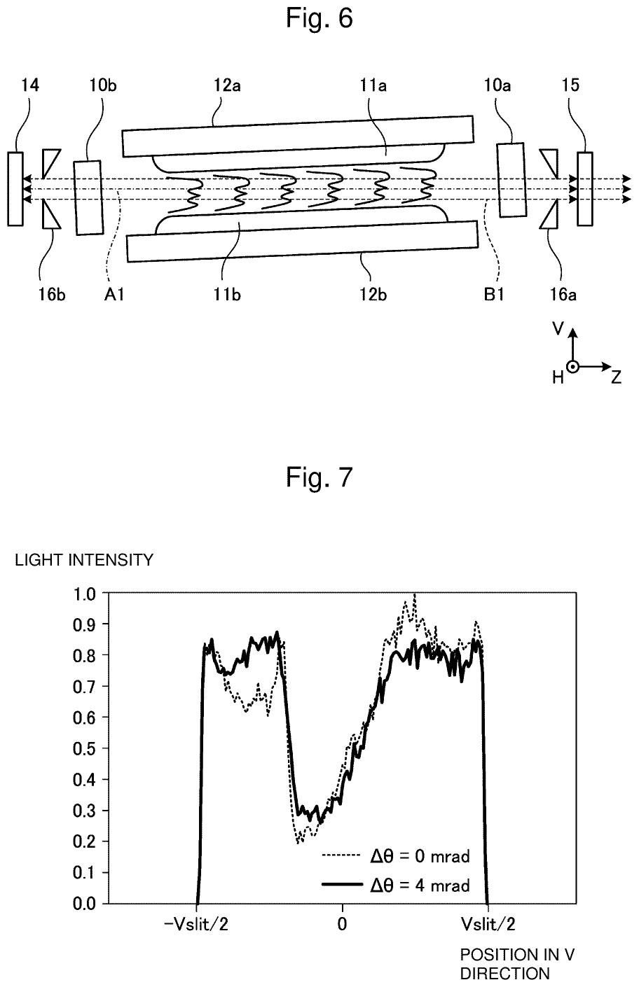

FIG. 6 conceptually illustrates the refractive index distribution between the discharge electrodes 11a and 11b of the first embodiment. By disposing the laser chamber 10 with a tilt, the rotation axis Acff1 of the cross-flow fan 17 that reflects the acoustic wave W1 and generates the acoustic wave W2 and the longitudinal direction of the rectifying guides 12a and 12b remain approximately parallel to the longitudinal direction of the discharge electrodes 11a and 11b. As a result, in a state where the refractive index distribution remains uniform in the longitudinal direction of the discharge electrodes 11a and 11b, the discharge electrodes 11a and 11b are tilted. This allows each ray included in the light beam B1 to pass through both high and low refractive index parts, thereby offsetting the influence of the refractive index distribution on the light beam B1 and suppressing the deviation of the light intensity distribution on the beam cross section.

By tilting the discharge electrodes 11a and 11b, some of the rays passing through the vicinity of the discharge electrode 11a or 11b may be output as a laser beam without being blocked by the slit 16a or 16b. However, by tilting the discharge electrodes 11a and 11b, a distance between the discharge electrode 11a or 11b and the light beam B1 changes along a traveling direction of the light beam B1, so that it is conceivable that adverse influence by local concentration of the discharge is mitigated.

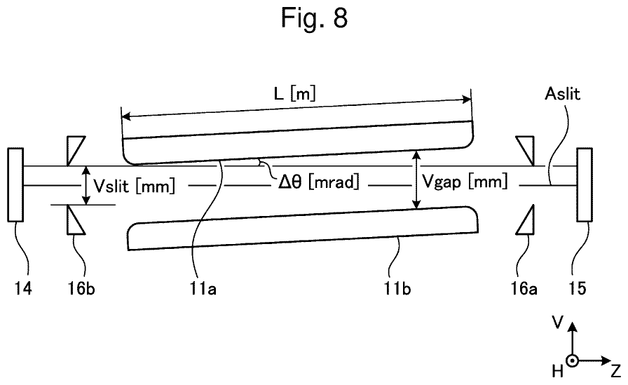

FIG. 7 illustrates a simulation result of the light intensity distribution in the V direction on the beam cross section of the laser beam output from the power oscillator PO. A horizontal axis in FIG. 7 indicates a position in the V direction, and the full V-direction beam width approximately matches a slit length Vslit (see FIG. 8). A vertical axis in FIG. 7 indicates a value obtained by integrating and normalizing light intensity in the H direction. In the first embodiment, when a longitudinal tilt Δθ of the discharge electrodes 11a and 11b relative to the optical axis A1 is set to 4 mrad, peak intensity is reduced to 87% compared to a case where the tilt Δθ is set to 0 mrad in the comparative example. If a damage to the optical element is due to two-photon absorption, since an occurrence probability of the two-photon absorption is proportional to a square of the light intensity, a service life of the optical element is expected to be extended by about 1.35 times compared to the comparative example.

### 2.3 Longitudinal Tilt Δθ of Discharge Electrodes 11a and 11b Relative to Optical Axis A1

FIG. 8 illustrates dimensions of parts of the discharge electrodes 11a and 11b and the slits 16a and 16b. A length along the longitudinal direction of each of the discharge electrodes 11a and 11b is defined as an electrode length L [m], and an interval along the V direction of the discharge electrodes 11a and 11b is defined as a gap length Vgap [mm]. An interval along the V direction of the slits 16a and 16b is defined as a slit length Vslit [mm]. The slit length Vslit is smaller than the gap length Vgap.

A slit axis Aslit defined by respective centers of the slits 16a and 16b is approximately parallel to the optical axis A1 defined by the optical resonator, and the longitudinal tilt Δθ [mrad] of the discharge electrodes 11a and 11b relative to the optical axis A1 is preferably greater than a tilt of the slit axis Aslit relative to the optical axis A1.

While an effective range of effective discharge is Vgap when the discharge electrodes 11a and 11b are not tilted, the effective range of the effective discharge can be approximated as Vgap−Δθ·L when the discharge electrodes 11a and 11b are tilted by Δθ. This Vgap−Δθ·L is preferably greater than or equal to the slit length Vslit as follows.
Vgap−Δθ·L≥Vslit

In the present embodiment, since the tilt Δθ is greater than 0, the tilt Δθ is preferably in a following range.
0<Δθ≤(Vgap−Vslit)/L

The approximation holds because Vgap is sufficiently small compared to the electrode length L, and further, taking a difference between Vgap and Vslit leads to a more accurate approximation.

Here, if the electrode length L is 0.7 m, the gap length Vgap is 15 mm, and the slit length Vslit is 10 mm, the tilt Δθ falls within a following range.
0 mrad<Δθ≤7.1 mrad

If a distance between the two slits 16a and 16b in an actual product is, for example, 1 m, and a tolerance of the V-direction position of the slits 16a and 16b is several hundred μm, there may be a variation of about 0.2 mrad in the slit axis Aslit. Further, the laser beam has a beam divergence angle of about 1 mrad to 3 mrad. Therefore, the tilt Δθ is preferably 1 mrad or more as follows.
1 mrad≤Δθ≤7.1 mrad

More preferably, the tilt Δθ is 3 mrad or more as follows.
3 mrad≤Δθ≤7.1 mrad

### 2.4 Effect

(1) The laser apparatus 1a according to the first embodiment includes the first optical resonator including the rear mirror 14 and the output coupling mirror 15, and the laser chamber 10 filled with the laser gas. The laser chamber 10 includes the pair of discharge electrodes 11a and 11b forming the discharge space DS where the light beam B1 that reciprocates in the first optical resonator passes through, the cross-flow fan 17 configured to circulate the laser gas in the laser chamber 10, the rectifying guides 12a and 12b configured to direct the laser gas in the laser chamber 10 between the discharge electrodes 11a and 11b, and the pair of windows 10a and 10b positioned in the optical path of the light beam B1, and is tilted in the V direction, which is the longitudinal direction of the cross section of the light beam B1, relative to the optical axis A1 defined by the first optical resonator.

Accordingly, by tilting the entire laser chamber 10 including the discharge electrodes 11a and 11b, the cross-flow fan 17, and the rectifying guides 12a and 12b, the discharge space DS having the refractive index distribution in the longitudinal direction of the cross section of the light beam B1 is tilted relative to the optical axis A1, so that each ray included in the light beam B1 passes through both the high and low refractive index parts. As a result, the influence of the refractive index distribution on the light beam B1 is offset and the deviation of the light intensity distribution on the cross section of the light beam B1 is suppressed.

(2) According to the first embodiment, the longitudinal tilt Δθ of the discharge electrodes 11a and 11b relative to the optical axis A1 is greater than the longitudinal tilt of the discharge electrodes 11a and 11b relative to the rotation axis Acff1 of the cross-flow fan 17.

Accordingly, by reducing the longitudinal tilt of the discharge electrodes 11a and 11b relative to the rotation axis Acff1 of the cross-flow fan 17, the refractive index distribution in the longitudinal direction of the discharge electrodes 11a and 11b becomes uniform, and the deviation of the light intensity distribution on the cross section of the light beam B1 is suppressed when the laser chamber 10 is tilted relative to the optical axis A1.

(3) According to the first embodiment, the longitudinal tilt Δθ of the discharge electrodes 11a and 11b relative to the optical axis A1 is greater than the longitudinal tilt of the discharge electrodes 11a and 11b relative to the longitudinal direction of the rectifying guides 12a and 12b.

Accordingly, by reducing the longitudinal tilt of the discharge electrodes 11a and 11b relative to the longitudinal direction of the rectifying guides 12a and 12b, the refractive index distribution in the longitudinal direction of the discharge electrodes 11a and 11b becomes uniform, and the deviation of the light intensity distribution on the cross section of the light beam B1 is suppressed when the laser chamber 10 is tilted relative to the optical axis A1.

(4) According to the first embodiment, the laser apparatus 1a further includes the pair of slits 16a and 16b whose slit length Vslit along the longitudinal direction of the cross section of the light beam B1 is smaller than the gap length Vgap of the discharge electrodes 11a and 11b. The laser chamber 10 is disposed between the rear mirror 14 and the output coupling mirror 15, and the slits 16a and 16b are disposed between the rear mirror 14 and the laser chamber 10 and between the output coupling mirror 15 and the laser chamber 10.

Accordingly, even if the laser chamber 10 is tilted, the V-direction beam width of the light beam B1 can be defined by the slits 16a and 16b, and quality of the laser beam output from the power oscillator PO can be maintained.

(5) According to the first embodiment, the longitudinal tilt Δθ of the discharge electrodes 11a and 11b relative to the optical axis A1 is greater than the tilt of the slit axis Aslit defined by the respective centers of the slits 16a and 16b relative to the optical axis A1.

Accordingly, by reducing the tilt of the slit axis Aslit relative to the optical axis A1, the V-direction beam width of the light beam B1 can be made equivalent to the slit length Vslit, and the quality of the laser beam output from the power oscillator PO can be maintained.

(6) According to the first embodiment, when the length along the longitudinal direction of the discharge electrodes 11a and 11b is L, the longitudinal tilt Δθ of the discharge electrodes 11a and 11b relative to the optical axis A1 is within the following range.
0<Δθ≤(Vgap−Vslit)/L

Accordingly, the laser chamber 10 can be tilted within a range where the light beam B1 is not blocked by the discharge electrodes 11a and 11b.

(7) According to the first embodiment, the longitudinal tilt Δθ of the discharge electrodes 11a and 11b relative to the optical axis A1 is within the following range.
1 mrad<Δθ≤7.1 mrad

Accordingly, even in consideration of the variation of the slit axis Aslit and the beam divergence angle, the effect of tilting the laser chamber 10 can be sufficiently obtained, and blocking of a part of the light beam B1 by the discharge electrodes 11a and 11b can be suppressed.

(8) According to the first embodiment, the laser apparatus 1a includes the pair of rails 18e and 18f disposed on either side of a plane that is perpendicular to the optical axis A1 and passes through the centroid of the laser chamber 10, and a plurality of wheels 18c and 18d that allow the laser chamber 10 to move along the rails 18e and 18f. Further, the lengths of the rails 18e and 18f along the longitudinal direction of the cross section of the light beam B1 are different from each other.

Accordingly, the tilt Δθ of the laser chamber 10 can be adjusted by V-direction lengths of the rails 18e and 18f.

(10) According to the first embodiment, the laser apparatus 1a includes the second optical resonator including the rear mirror 24 and the output coupling mirror 25, and the laser chamber 20 filled with the laser gas. The laser chamber 20 includes the pair of discharge electrodes 21a and 21b forming the discharge space where the light beam B2 that reciprocates in the second optical resonator passes through, the cross-flow fan 27 configured to circulate the laser gas in the laser chamber 20, the rectifying guides 22a and 22b configured to direct the laser gas in the laser chamber 20 between the discharge electrodes 21a and 21b, and the pair of windows 20a and 20b positioned in the optical path of the light beam B2.

Accordingly, even in a configuration that includes the master oscillator MO and the power oscillator PO, degradation of the optical elements can be suppressed.

(11) According to the first embodiment, the rear mirror 14 is formed of a partial reflective mirror, and the first optical resonator is configured to amplify the laser beam output from the second optical resonator and incident through the rear mirror 14 and to output the amplified laser beam.

Accordingly, by tilting the laser chamber 10 of the power oscillator PO, the degradation of the optical elements of the power oscillator PO can be suppressed.

(13) According to the first embodiment, the longitudinal tilt Δθ of the discharge electrodes 11a and 11b relative to the optical axis A1 is greater than the longitudinal tilt of the discharge electrodes 21a and 21b relative to the optical axis A2 defined by the second optical resonator.

Accordingly, by reducing the longitudinal tilt of the discharge electrodes 21a and 21b relative to the optical axis A2, the laser chamber 20 can be installed as before.

(14) According to the first embodiment, the longitudinal tilt Δθ of the discharge electrodes 11a and 11b relative to the optical axis A1 is greater than the tilt of the optical axis A1 relative to the optical axis A2 defined by the second optical resonator.

Accordingly, by reducing the tilt of the optical axis A1 defined by the optical resonator of the power oscillator PO relative to the optical axis A2 defined by the optical resonator of the master oscillator MO, the optical axes A1 and A2 can be easily adjusted.

In other respects, the first embodiment is similar to the comparative example.

### 3. Wheels 18g and 18h Having Different Diameters

### 3.1 Configuration

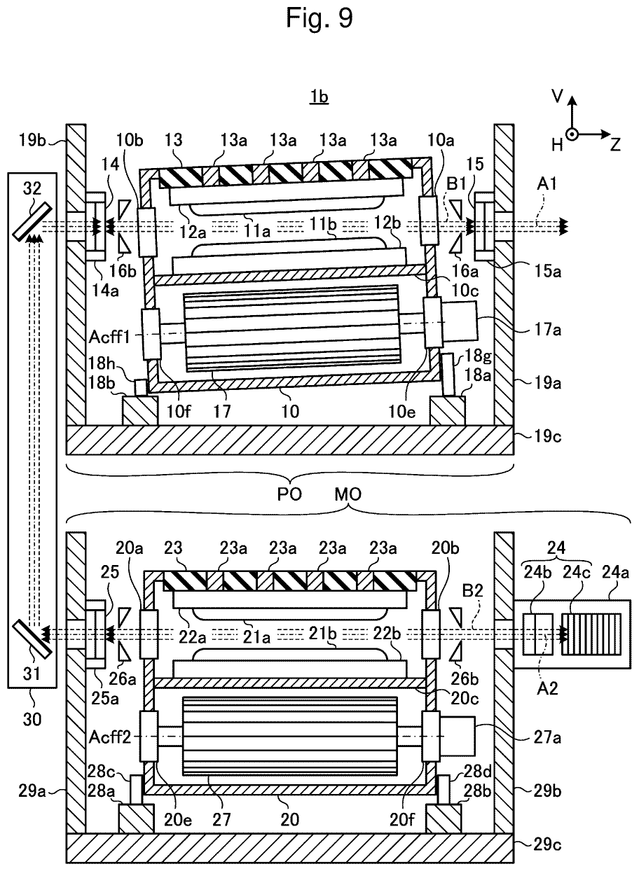

FIG. 9 schematically illustrates a configuration of a laser apparatus 1b according to a first modification. Instead of the wheels 18c and 18d in the first embodiment, wheels 18g and 18h are used in the first modification. Since the wheels 18g and 18h have different diameters from each other, the laser chamber 10 is disposed with a tilt. The rails 18a and 18b may be the same as those in the comparative example.

### 3.2 Effect

(9) According to the first modification, the laser apparatus 1b includes the wheels 18g and 18h disposed on either side of the plane that is perpendicular to the optical axis A1 and passes through the centroid of the laser chamber 10, allowing the laser chamber 10 to move in the chamber moving direction that intersects the optical axis A1. Further, of the wheels 18g and 18h, the wheel 18g positioned on one side of the plane and the wheel 18h positioned on the other side have different diameters from each other.

Accordingly, by using the wheels 18g and 18h having the different diameters, the laser chamber 10 can be installed on the existing rails 18a and 18b.

In other respects, the first modification is the same as the first embodiment.

### 4. Example of Tilting Laser Chamber 20 of Master Oscillator MO

### 4.1 Configuration

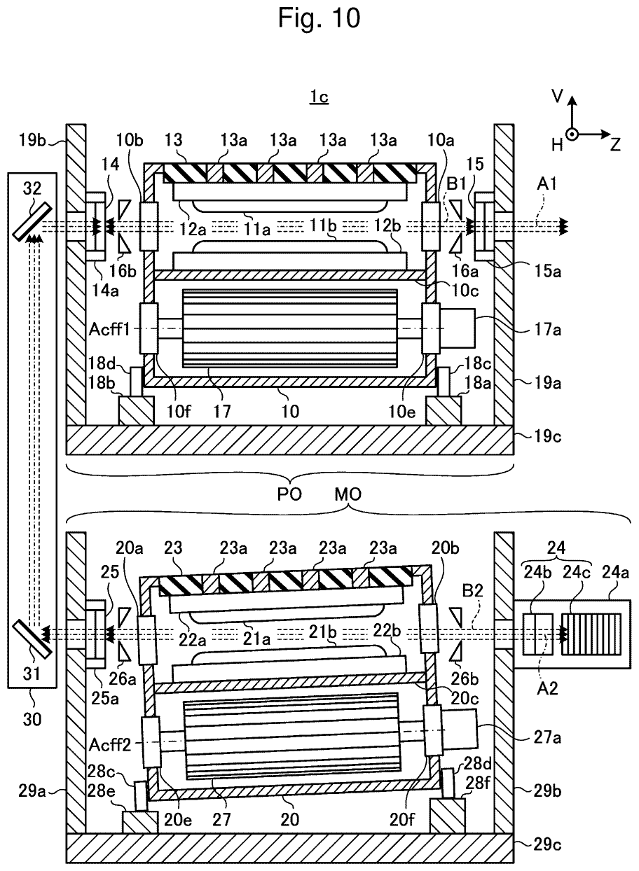

FIG. 10 schematically illustrates a configuration of a laser apparatus 1c according to a second modification. Instead of tilting the laser chamber 10 of the power oscillator PO in the first embodiment, the laser chamber 20 of the master oscillator MO is tilted in the second modification.

That is, in the second modification, the power oscillator PO is the same as that in the comparative example, and the master oscillator MO corresponds to the one in which the laser chamber 20 is tilted in the same manner as the laser chamber 10 tilted in the first embodiment. While FIG. 10 illustrates an example of tilting the laser chamber 20 by using rails 28e and 28f having different lengths along the V direction, the rails 28a and 28b similar to those in the comparative example and wheels having different diameters from each other may be used similarly to the first modification.

The laser chamber 20 in the second modification corresponds to the first laser chamber in the present disclosure, and the windows 20a and 20b in the second modification correspond to the first windows in the present disclosure. The discharge electrodes 21a and 21b in the second modification correspond to the first discharge electrodes in the present disclosure, and the rectifying guides 22a and 22b in the second modification correspond to the first rectifying guides in the present disclosure. The rear mirror 24 in the second modification corresponds to the first rear mirror in the present disclosure, the output coupling mirror 25 in the second modification corresponds to the first output coupling mirror in the present disclosure, and the optical resonator formed of the rear mirror 24 and the output coupling mirror 25 in the second modification corresponds to the first optical resonator in the present disclosure. The cross-flow fan 27 in the second modification corresponds to the first cross-flow fan in the present disclosure. The optical axis A2 in the second modification corresponds to the first optical axis in the present disclosure, and the light beam B2 in the second modification corresponds to the first light beam in the present disclosure.

The laser chamber 10 in the second modification corresponds to the second laser chamber in the present disclosure, and the windows 10a and 10b in the second modification correspond to the second windows in the present disclosure. The discharge electrodes 11a and 11b in the second modification correspond to the second discharge electrodes in the present disclosure, and the rectifying guides 12a and 12b in the second modification correspond to the second rectifying guides in the present disclosure. The rear mirror 14 in the second modification corresponds to the second rear mirror in the present disclosure, the output coupling mirror 15 in the second modification corresponds to the second output coupling mirror in the present disclosure, and the optical resonator formed of the rear mirror 14 and the output coupling mirror 15 in the second modification corresponds to the second optical resonator in the present disclosure. The cross-flow fan 17 in the second modification corresponds to the second cross-flow fan in the present disclosure. The optical axis A1 in the second modification corresponds to the second optical axis in the present disclosure, and the light beam B1 in the second modification corresponds to the second light beam in the present disclosure.

### 4.2 Effect

(12) According to the second modification, the laser apparatus 1c includes the first optical resonator including the rear mirror 24 and the output coupling mirror 25, and the laser chamber 20 filled with the laser gas. The laser chamber 20 includes the pair of discharge electrodes 21a and 21b forming the discharge space where the light beam B2 that reciprocates in the first optical resonator passes through, the cross-flow fan 27 configured to circulate the laser gas in the laser chamber 20, the rectifying guides 22a and 22b configured to direct the laser gas in the laser chamber 20 between the discharge electrodes 21a and 21b, and the pair of windows 20a and 20b positioned in the optical path of the light beam B2, and is tilted in the V direction, which is the longitudinal direction of the cross section of the light beam B2, relative to the optical axis A2 defined by the first optical resonator. The laser apparatus 1c further includes the second optical resonator including the rear mirror 14 and the output coupling mirror 15, and the laser chamber 10 filled with the laser gas. The laser chamber 10 includes the pair of discharge electrodes 11a and 11b forming the discharge space DS where the light beam B1 that reciprocates in the second optical resonator passes through, the cross-flow fan 17 configured to circulate the laser gas in the laser chamber 10, the rectifying guides 12a and 12b configured to direct the laser gas in the laser chamber 10 between the discharge electrodes 11a and 11b, and the pair of windows 10a and 10b positioned in the optical path of the light beam B1. The rear mirror 14 is formed of a partial reflective mirror, and the second optical resonator is configured to amplify the laser beam output from the first optical resonator and incident through the rear mirror 14 and to output the amplified laser beam. The laser chamber 10 does not need to be tilted relative to the optical axis A1.

Accordingly, by tilting the laser chamber 20 of the master oscillator MO, it is possible to not only suppress the deviation of the light intensity distribution on the beam cross section of the laser beam output from the master oscillator MO and to suppress the degradation of the optical elements of the power oscillator PO but also suppress the degradation of the optical elements of the master oscillator MO.

In other respects, the second modification is the same as the first embodiment.

### 5. Example of Tilting both Laser Chambers 10 and 20

### 5.1 Configuration

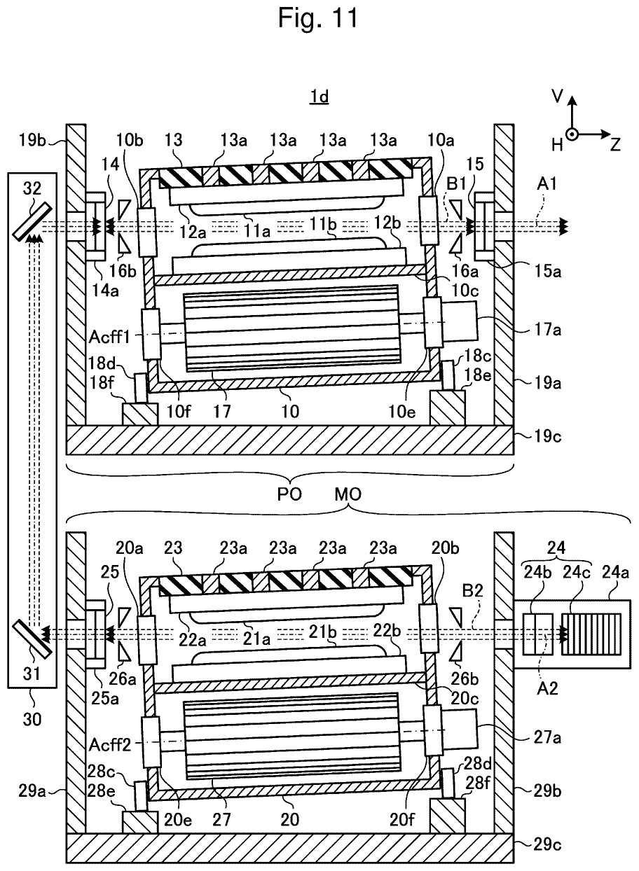

FIG. 11 schematically illustrates a configuration of a laser apparatus 1d according to a third modification. In the third modification, both the laser chamber 10 of the power oscillator PO and the laser chamber 20 of the master oscillator MO are tilted.

That is, in the third modification, the power oscillator PO is the same as that in the first embodiment, and the master oscillator MO is the same as that in the second modification. While FIG. 11 illustrates an example of tilting the laser chambers 10 and 20 using the rails 18e, 18f, 28e, and 28f, similarly to the first modification, the rails 18a and 18b similar to those in the comparative example and the wheels 18g and 18h having different diameters from each other may be used, or the rails 28a and 28b similar to those in the comparative example and the wheels having different diameters from each other may be used.

The laser chambers 10 and 20 are preferably tilted in the same direction as each other. Further, it is preferable that the longitudinal direction of the discharge electrodes 11a and 11b be approximately parallel to the longitudinal direction of the discharge electrodes 21a and 21b. It is preferable that both the longitudinal tilt Δθ of the discharge electrodes 11a and 11b relative to the optical axis A1 and the longitudinal tilt of the discharge electrodes 21a and 21b relative to the optical axis A2 be greater than the tilt of the optical axis A2 relative to the optical axis A1, and be greater than the longitudinal tilt of the discharge electrodes 21a and 21b relative to the longitudinal direction of the discharge electrodes 11a and 11b.

### 5.2 Effect

(16) According to the third modification, the laser apparatus 1d includes the first optical resonator including the rear mirror 14 and the output coupling mirror 15, and the laser chamber 10 filled with the laser gas, and the laser chamber 10 is tilted in the longitudinal direction of the cross section of the light beam B1 relative to the optical axis A1 defined by the first optical resonator. Further, the laser apparatus 1d includes the second optical resonator including the rear mirror 24 and the output coupling mirror 25, and the laser chamber 20 filled with the laser gas. The laser chamber 20 includes the pair of discharge electrodes 21a and 21b forming the discharge space where the light beam B2 that reciprocates in the second optical resonator passes through, the cross-flow fan 27 configured to circulate the laser gas in the laser chamber 20, the rectifying guides 22a and 22b configured to direct the laser gas in the laser chamber 20 between the discharge electrodes 21a and 21b, and the pair of windows 20a and 20b positioned in the optical path of the light beam B2, and is tilted in the longitudinal direction of the cross section of the light beam B2 relative to the optical axis A2 defined by the second optical resonator. The rear mirror 14 is formed of a partial reflective mirror, and the first optical resonator is configured to amplify the laser beam output from the second optical resonator and incident through the rear mirror 14 and to output the amplified laser beam.

Accordingly, by tilting the laser chamber 10 of the power oscillator PO relative to the optical axis A1 of the optical resonator and tilting the laser chamber 20 of the master oscillator MO relative to the optical axis A2 of the optical resonator, the light intensity distribution on the beam cross section can be made smoother, and the degradation of the optical elements can be suppressed.

(17) According to the third modification, the longitudinal tilt Δθ of the discharge electrodes 11a and 11b relative to the optical axis A1 and the longitudinal tilt of the discharge electrodes 21a and 21b relative to the optical axis A2 are greater than the tilt of the optical axis A2 relative to the optical axis A1, and are greater than the longitudinal tilt of the discharge electrodes 21a and 21b relative to the longitudinal direction of the discharge electrodes 11a and 11b.

Accordingly, by reducing the tilt of the optical axis A2 relative to the optical axis A1 and also reducing the longitudinal tilt of the discharge electrodes 21a and 21b relative to the longitudinal direction of the discharge electrodes 11a and 11b, the optical axes A1 and A2 can be easily adjusted and the laser chambers 10 and 20 can be easily installed and positioned.

In other respects, the third modification is the same as the first embodiment.

### 6. Example of Not Including Power Oscillator PO

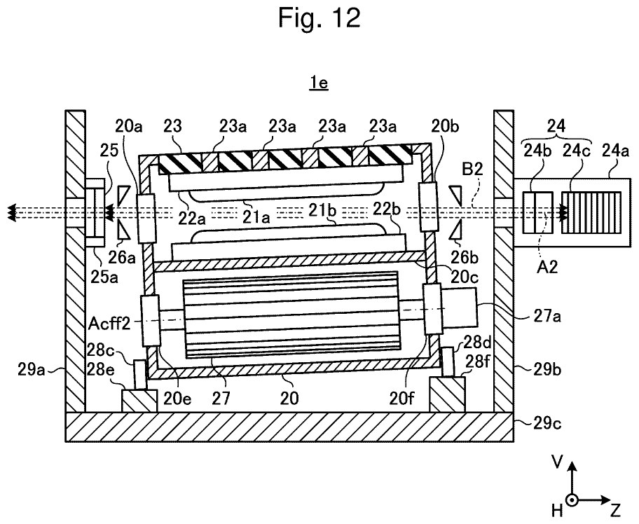

FIG. 12 schematically illustrates a configuration of a laser apparatus 1e according to a fourth modification. The fourth modification includes a configuration similar to the master oscillator MO in the second modification and may not include the power oscillator PO and the beam steering unit 30.

While FIG. 12 illustrates an example of tilting the laser chamber 20 by using the rails 28e and 28f, the rails 28a and 28b similar to those in the comparative example and the wheels having different diameters from each other may be used similarly to the first modification.

In other respects, the fourth modification is the same as the second modification.

### 7. Laser Apparatus 1f with Tilted Optical Resonator

### 7.1 Configuration

FIG. 13 schematically illustrates a configuration of a laser apparatus 1f according to a second embodiment. In the laser apparatus 1f, instead of the laser chamber 10, the optical resonator formed of the rear mirror 14 and the output coupling mirror 15 is tilted relative to a base plate 19c. As a result, the laser chamber 10 is disposed with a tilt relative to the optical axis A1 defined by the optical resonator.

The rear mirror 14 is supported with a tilt relative to a cavity plate 19b via a holder 14b instead of a holder 14a, and the output coupling mirror 15 is supported with a tilt relative to a cavity plate 19a via a holder 15b instead of a holder 15a. As a result, the cavity plates 19a and 19b are disposed with a tilt relative to the optical axis A1.

In the laser apparatus 1f, slits 16c and 16d are disposed instead of the slits 16a and 16b. The slit axis Aslit (see FIG. 8) defined by the respective centers of the slits 16c and 16d is approximately parallel to the optical axis A1.

The optical axis A1 is tilted relative to the optical axis A2. The longitudinal direction of the discharge electrodes 11a and 11b of the power oscillator PO and the longitudinal direction of the discharge electrodes 21a and 21b of the master oscillator MO may be approximately parallel. A non-illustrated beam steering unit may be disposed in an optical path of the laser beam output from the power oscillator PO to adjust a traveling direction of the laser beam.

While FIG. 13 illustrates an example of tilting the optical resonator of the power oscillator PO relative to the base plate 19c, the optical resonator of the master oscillator MO may be tilted relative to the base plate 29c, instead of tilting the optical resonator of the power oscillator PO relative to the base plate 19c. This concept is similar to the second modification.

In addition, the optical resonators of the power oscillator PO and the master oscillator MO may be tilted relative to the base plates 19c and 29c, respectively. The directions of tilting the optical resonators of the power oscillator PO and the master oscillator MO are preferably the same. This concept is similar to the third modification.

Further, the laser apparatus 1f includes the master oscillator MO with the optical resonator tilted relative to the base plate 29c, and may not include the power oscillator PO and the beam steering unit 30. This concept is similar to the fourth modification.

### 7.2 Effect

(15) According to the second embodiment, the longitudinal tilt Δθ of the discharge electrodes 11a and 11b relative to the optical axis A1 is greater than the longitudinal tilt of the discharge electrodes 21a and 21b relative to the longitudinal direction of the discharge electrodes 11a and 11b.

Accordingly, by reducing the longitudinal tilt of the discharge electrodes 21a and 21b relative to the longitudinal direction of the discharge electrodes 11a and 11b, the laser chambers 10 and 20 can be easily installed and positioned.

(18) According to the second embodiment, the laser apparatus 1f includes a pair of cavity plates 19b and 19a supporting the rear mirror 14 and the output coupling mirror 15, and the cavity plates 19b and 19a are tilted relative to the optical axis A1.

Accordingly, without tilting the laser chamber 10 relative to the cavity plates 19b and 19a, by tilting the optical axis A1, the deviation of the light intensity distribution on the beam cross section can be suppressed and the degradation of the optical elements can be suppressed.

In other respects, the second embodiment is similar to the first embodiment.

### 8. Example of Tilting Cavity Plates 19e and 19f

### 8.1 Configuration

FIG. 14 schematically illustrates a configuration of a laser apparatus 1g according to a fifth modification. In the fifth modification, by tilting the cavity plates 19e and 19f relative to the laser chamber 10, the optical resonator is tilted relative to the base plate 19c. The output coupling mirror 15 and the rear mirror 14 are supported by the cavity plates 19e and 19f via the holders 15a and 14a, respectively. As a result, the laser chamber 10 is disposed with a tilt relative to the optical axis A1 defined by the optical resonator.

### 8.2 Effect

(19) According to the fifth modification, the laser apparatus 1g includes the pair of cavity plates 19f and 19e supporting the rear mirror 14 and the output coupling mirror 15, and the cavity plates 19f and 19e are tilted relative to the laser chamber 10.

Accordingly, by tilting the cavity plates 19f and 19e supporting the optical resonator, the optical axis A1 can be tilted, the deviation of the light intensity distribution on the beam cross section can be suppressed, and the degradation of the optical elements can be suppressed.

In other respects, the fifth modification is the same as the second embodiment.

### 9. Others

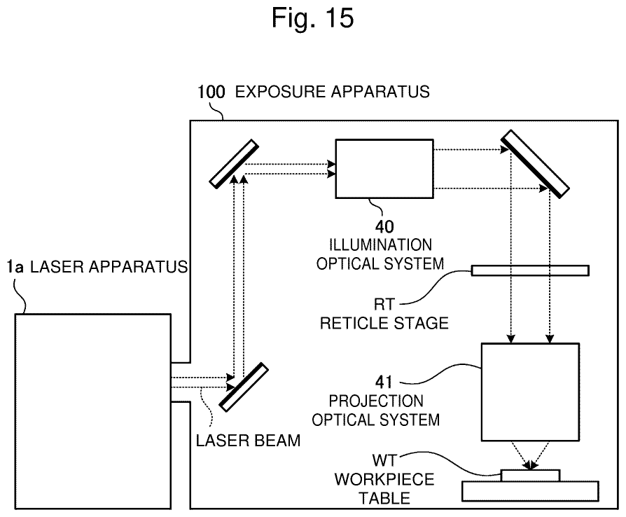

FIG. 15 schematically illustrates a configuration of an exposure apparatus 100 connected to the laser apparatus 1a. The laser apparatus 1a generates a laser beam and outputs it to the exposure apparatus 100.

In FIG. 15, the exposure apparatus 100 includes an illumination optical system 40 and a projection optical system 41. The illumination optical system 40 illuminates a reticle pattern of a non-illustrated reticle disposed on a reticle stage RT with the laser beam incident from the laser apparatus 1a. The laser beam having transmitted through the reticle is imaged on a non-illustrated workpiece disposed on a workpiece table WT by reduced projection through the projection optical system 41. The workpiece is a photosensitive substrate such as a semiconductor wafer on which photoresist is applied. The exposure apparatus 100 synchronously translates the reticle stage RT and the workpiece table WT to expose the workpiece to the laser beam reflecting the reticle pattern. An electronic device can be manufactured through a plurality of processes after the reticle pattern is transferred onto the semiconductor wafer through an exposure process as described above.

While FIG. 15 illustrates an example where the exposure apparatus 100 is connected to the laser apparatus 1a, it may be connected to any of the laser apparatuses 1b to 1g.

The description above is intended to be illustrative and the present disclosure is not limited thereto. Therefore, it would be obvious to those skilled in the art that various modifications to the embodiments of the present disclosure would be possible without departing from the spirit and the scope of the claims. Further, it would be also obvious to those skilled in the art that embodiments of the present disclosure would be appropriately combined.

The terms used throughout the present specification and the claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A laser apparatus comprising:
a first optical resonator including a first rear mirror and a first output coupling mirror; and
a first laser chamber filled with a laser gas and including
a pair of first discharge electrodes forming a discharge space where a first light beam that reciprocates in the first optical resonator passes through,
a first cross-flow fan configured to circulate the laser gas in the first laser chamber,
a first rectifying guide configured to direct the laser gas in the first laser chamber between the first discharge electrodes, and
a pair of first windows positioned in an optical path of the first light beam,
the first laser chamber being tilted in a longitudinal direction of a cross section of the first light beam relative to a first optical axis defined by the first optical resonator.

2. The laser apparatus according to claim 1, wherein
a longitudinal tilt of the first discharge electrodes relative to the first optical axis is greater than a longitudinal tilt of the first discharge electrodes relative to a rotation axis of the first cross-flow fan.

3. The laser apparatus according to claim 1, wherein
a longitudinal tilt of the first discharge electrodes relative to the first optical axis is greater than a longitudinal tilt of the first discharge electrodes relative to a longitudinal direction of the first rectifying guide.

4. The laser apparatus according to claim 1, further comprising
a pair of slits whose slit length along the longitudinal direction of the cross section of the first light beam is smaller than a gap length of the first discharge electrodes, wherein
the first laser chamber is disposed between the first rear mirror and the first output coupling mirror, and
the slits are disposed between the first rear mirror and the first laser chamber and between the first output coupling mirror and the first laser chamber.

5. The laser apparatus according to claim 4, wherein
a longitudinal tilt of the first discharge electrodes relative to the first optical axis is greater than a tilt of a slit axis defined by respective centers of slits relative to the first optical axis.

6. The laser apparatus according to claim 4, wherein
when a length along a longitudinal direction of the first discharge electrodes is L, the gap length is Vgap, and the slit length is Vslit, a longitudinal tilt Δθ of the first discharge electrodes relative to the first optical axis is within a following range.
0<Δθ≤(Vgap−Vslit)/L

7. The laser apparatus according to claim 1, wherein
a longitudinal tilt Δθ of the first discharge electrodes relative to the first optical axis is within a following range.
1 mrad<Δθ≤7.1 mrad

8. The laser apparatus according to claim 1, further comprising:
a pair of rails disposed on either side of a plane that is perpendicular to the first optical axis and passes through a centroid of the first laser chamber; and
a plurality of wheels that allow the first laser chamber to move along the rails, wherein
lengths of the rails along the longitudinal direction of the cross section of the first light beam are different from each other.

9. The laser apparatus according to claim 1, further comprising
a plurality of wheels disposed on either side of a plane that is perpendicular to the first optical axis and passes through a centroid of the first laser chamber, allowing the first laser chamber to move in a chamber moving direction that intersects the first optical axis, wherein
the wheel positioned on one side of the plane and the wheel positioned on the other side of the plane have different diameters from each other.

10. The laser apparatus according to claim 1, further comprising:
a second optical resonator including a second rear mirror and a second output coupling mirror; and
a second laser chamber filled with the laser gas and including
a pair of second discharge electrodes forming a discharge space where a second light beam that reciprocates in the second optical resonator passes through,
a second cross-flow fan configured to circulate the laser gas in the second laser chamber,
a second rectifying guide configured to direct the laser gas in the second laser chamber between the second discharge electrodes, and
a pair of second windows positioned in an optical path of the second light beam, wherein
one of the first and second optical resonators is configured to amplify a laser beam output from the other of the first and second optical resonators and to output the amplified laser beam.

11. The laser apparatus according to claim 10, wherein
the first rear mirror is formed of a partial reflective mirror, and
the first optical resonator is configured to amplify a laser beam output from the second optical resonator and incident through the first rear mirror and to output the amplified laser beam.

12. The laser apparatus according to claim 10, wherein
the second rear mirror is formed of a partial reflective mirror, and
the second optical resonator is configured to amplify a laser beam output from the first optical resonator and incident through the second rear mirror and to output the amplified laser beam.

13. The laser apparatus according to claim 10, wherein
a longitudinal tilt of the first discharge electrodes relative to the first optical axis is greater than a longitudinal tilt of the second discharge electrodes relative to a second optical axis defined by the second optical resonator.

14. The laser apparatus according to claim 10, wherein
a longitudinal tilt of the first discharge electrodes relative to the first optical axis is greater than a tilt of the first optical axis relative to a second optical axis defined by the second optical resonator.

15. The laser apparatus according to claim 10, wherein
a longitudinal tilt of the first discharge electrodes relative to the first optical axis is greater than a longitudinal tilt of the second discharge electrodes relative to a longitudinal direction of the first discharge electrodes.

16. The laser apparatus according to claim 1, further comprising:
a second optical resonator including a second rear mirror and a second output coupling mirror; and
a second laser chamber filled with the laser gas and including
a pair of second discharge electrodes forming a discharge space where a second light beam that reciprocates in the second optical resonator passes through,
a second cross-flow fan configured to circulate the laser gas in the second laser chamber,
a second rectifying guide configured to direct the laser gas in the second laser chamber between the second discharge electrodes, and
a pair of second windows positioned in an optical path of the second light beam,
the second laser chamber being tilted in a longitudinal direction of a cross section of the second light beam relative to a second optical axis defined by the second optical resonator, wherein
the first rear mirror is formed of a partial reflective mirror, and
the first optical resonator is configured to amplify a laser beam output from the second optical resonator and incident through the first rear mirror and to output the amplified laser beam.

17. The laser apparatus according to claim 16, wherein
a longitudinal tilt of the first discharge electrodes relative to the first optical axis and a longitudinal tilt of the second discharge electrodes relative to the second optical axis are greater than a tilt of the second optical axis relative to the first optical axis, and are greater than the longitudinal tilt of the second discharge electrodes relative to a longitudinal direction of the first discharge electrodes.

18. The laser apparatus according to claim 1, further comprising
a pair of cavity plates supporting the first rear mirror and the first output coupling mirror, wherein
the cavity plates are tilted relative to the first optical axis.

19. The laser apparatus according to claim 1, further comprising
a pair of cavity plates supporting the first rear mirror and the first output coupling mirror, wherein
the cavity plates are tilted relative to the first laser chamber.

20. A method for manufacturing an electronic device, the method comprising:
generating a laser beam with a laser apparatus, the laser apparatus including
a first optical resonator including a first rear mirror and a first output coupling mirror, and
a first laser chamber filled with a laser gas and including
a pair of first discharge electrodes forming a discharge space where a first light beam that reciprocates in the first optical resonator passes through,
a first cross-flow fan configured to circulate the laser gas in the first laser chamber,
a first rectifying guide configured to direct the laser gas in the first laser chamber between the first discharge electrodes, and
a pair of first windows positioned in an optical path of the first light beam,
the first laser chamber being tilted in a longitudinal direction of a cross section of the first light beam relative to a first optical axis defined by the first optical resonator;
outputting the laser beam to an exposure apparatus; and
exposing a photosensitive substrate to the laser beam in the exposure apparatus to manufacture the electronic device.
